(19) United States
(12) Patent Application Publication
(10) Pub. No.: US 2026/0075359 A1
(43) Pub. Date: Mar. 12, 2026

(54) IMAGING APPARATUS

(71) Applicant: Panasonic Intellectual Property Management Co., Ltd., Osaka (JP)

(72) Inventor: Hiroki KASUGAI, Osaka (JP)

(73) Assignee: Panasonic Intellectual Property Management Co., Ltd., Osaka (JP)

(21) Appl. No.: 19/321,187

(22) Filed: Sep. 6, 2025

(30) Foreign Application Priority Data
Sep. 12, 2024 (JP) 2024-158587

(51) Int. Cl. H04R 1/40; H04R 1/10; H04R 3/00

(52) U.S. Cl. CPC H04R 1/406; H04R 1/1016; H04R 3/005; H04R 2430/20; H04R 2499/11

(57) ABSTRACT

An imaging apparatus includes: an image sensor to capture an image of a subject to generate image data; a communicator to perform data communication with a sound collector; an audio processor to form a directivity in a sound collected by the sound collector; and a controller to control sound collection by the sound collector. The sound collector is worn on a head of a user, and includes a plurality of microphones arranged at respective predetermined positions on the head wearing the sound collector. The controller controls the communicator to receive, from the sound collector, audio data indicating the sound collected with the image sensor capturing the image, and controls the directivity in the received audio data by the audio processor according to the arrangement of the plurality of microphones on the head wearing the sound collector, and outputs controlled audio data to be recorded in association with generated image data.

### TECHNICAL FIELD

The present disclosure relates to an imaging apparatus that acquires a sound when performing image shooting such as shooting of a moving image.

### BACKGROUND ART

JP 2015-142203 A discloses an imaging device including a microphone and an imaging unit capable of shooting a moving image. The imaging unit records audio data generated by the microphone and moving image data of a moving image shot by the imaging unit in association with each other. When a moving image is shot, noise such as lens drive noise and wind noise is sometimes contained in a sound captured by the microphone of the imaging device. In the imaging device of JP 2015-142203 A, a smartphone is used, in addition to the microphone, as an external recording device to acquire a sound with reduced noise.

### SUMMARY

The present disclosure provides an imaging apparatus capable of easily acquiring a sound that meets an intention of a user using the imaging apparatus.

An imaging apparatus according to an aspect of the present disclosure includes an image sensor, a communicator, an audio processor, and a controller. The image sensor is configured to capture an image of a subject to generate image data. The communicator is configured to perform data communication with a sound collector. The audio processor is configured to form a directivity in a sound collected by the sound collector. The controller is configured to control sound collection by the sound collector. The sound collector is worn on a head of a user, and includes a plurality of microphones arranged at respective predetermined positions on the head wearing the sound collector. The controller controls the communicator to receive, from the sound collector, audio data indicating a sound collected with the image sensor capturing the image. The controller controls the directivity in the received audio data by the audio processor according to the arrangement of the plurality of microphones on the head wearing the sound collector. The controller outputs controlled audio data to be recorded in association with the image data generated by the image sensor.

With the imaging apparatus according to the present disclosure, it is possible to easily acquire a sound that meets an intention of a user using the imaging apparatus.

### BRIEF DESCRIPTION OF DRAWINGS

FIG. 1 is a diagram for illustrating an imaging system according to a first embodiment of the present disclosure;

FIG. 2 is a diagram illustrating a configuration of a digital camera in the imaging system;

FIG. 3 is a diagram for illustrating earphones worn by a user in the imaging system;

FIG. 4 illustrates a configuration of each earphone in the imaging system;

FIG. 5 is a flowchart illustrating an operation of the digital camera at the time of connection with the earphone;

FIG. 6 is a flowchart illustrating a device setting processing in the digital camera;

FIGS. 7A and 7B are diagrams for illustrating a calculation of a distance between the earphones in the digital camera;

FIG. 8 is a flowchart illustrating an operation in the digital camera performed with moving image shooting;

FIG. 9 is a diagram for illustrating a beamformer in the digital camera;

FIGS. 10A and 10B are diagrams for illustrating recording modes in the digital camera;

FIGS. 11A and 11B are diagrams for illustrating an example of changing the recording modes in the moving image shooting;

FIG. 12 is a flowchart illustrating a reproducing operation in the digital camera after the moving image shooting; and

FIG. 13 is a diagram for illustrating an imaging system according to a modification of the first embodiment.

### DETAILED DESCRIPTION

Hereinafter, embodiments will be described in detail with reference to the drawings as appropriate. However, detailed description may be omitted more than necessary. For example, detailed descriptions of already well-known matters and duplicated descriptions for substantially identical configurations may be omitted. This is to avoid unnecessary redundancy of the following description and to facilitate understanding by those skilled in the art. The inventor(s) provides the accompanying drawings and the following description for those skilled in the art to fully understand the present disclosure, and does not intend them to limit the subject matter described in the scope of claims.

### First Embodiment

In a first embodiment, an imaging system will be described that acquires a sound in moving image shooting.

### 1. Configuration of Imaging System

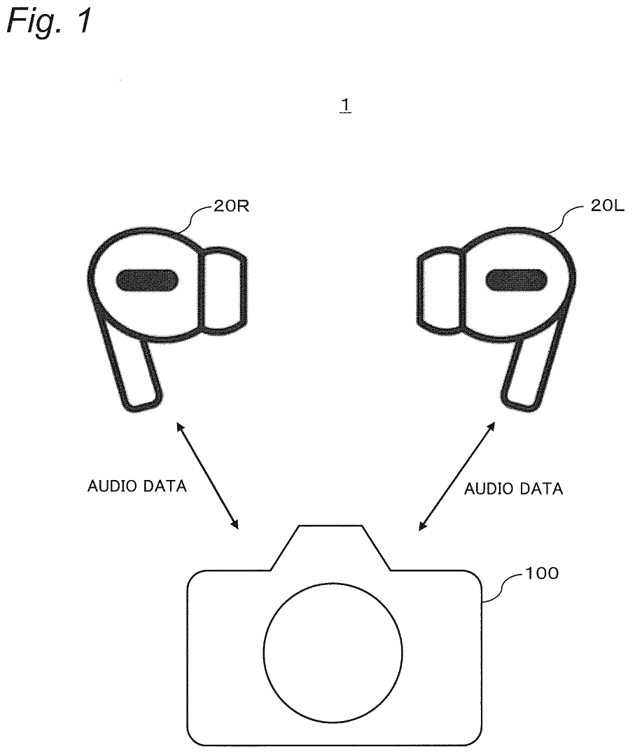

The imaging system in the first embodiment of the present disclosure will be described with reference to FIG. 1.

As illustrated in FIG. 1, an imaging system 1 of the present embodiment includes a digital camera 100 and two earphones 20L and 20R. In the imaging system 1 of the present embodiment, each of the earphones 20L and 20R incorporates microphones and is connected to enable data communication with the digital camera 100. Hereinafter, the earphones 20L and 20R are also collectively referred to as an earphone 20. The digital camera 100 and the earphone 20 of the present system 1 are examples of the imaging apparatus and the sound collector in the present embodiment, respectively.

In the present system 1, when moving image shooting is performed with the digital camera 100 in a state where the earphone 20 is worn in ears of a user such as a cameraman, audio data indicating a sound collected by the microphones, and the like, are transmitted from the earphone 20 to the digital camera 100. Furthermore, for example, after the moving image shooting is performed, audio data and the like for reproduction of the shot moving image are transmitted from the digital camera 100 to the earphone 20.

Configurations of the digital camera 100 and the earphone 20 in the present system 1 as described above will be described as follows.

### 1-1. Configuration of Digital Camera

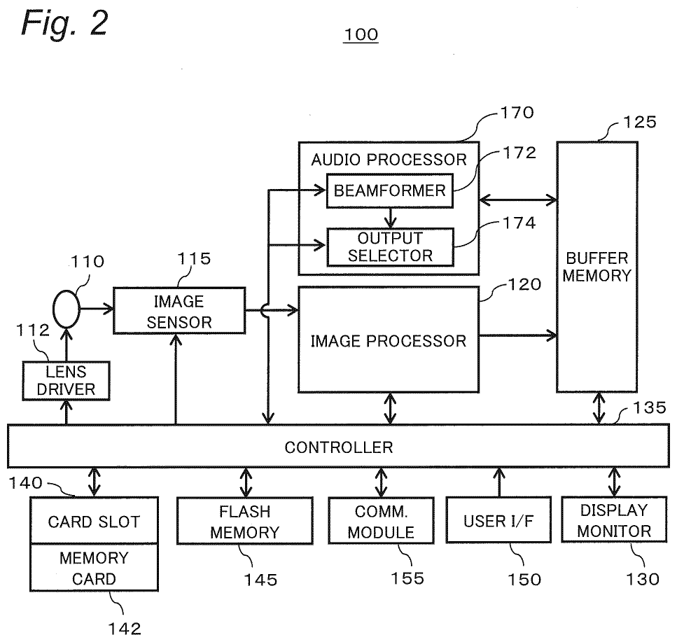

FIG. 2 is a diagram illustrating the configuration of the digital camera 100 in the present system 1. The digital camera 100 includes an image sensor 115, an image processor 120, a display monitor 130, and a controller 135. Further, the digital camera 100 includes a buffer memory 125, a card slot 140, a flash memory 145, a user interface 150, and a communication module 155.

The digital camera 100 includes, for example, an optical system 110 and a lens driver 112. The optical system 110 and the lens driver 112 may constitute an interchangeable lens detachable from the main body of the digital camera 100.

The optical system 110 includes a focus lens, a zoom lens, an optical image stabilization lens (OIS), a diaphragm, a shutter, and the like. The focus lens is a lens for changing the focus state of a subject image formed on the image sensor 115. The zoom lens is a lens for changing the magnification of the subject image formed by the optical system. Each of the focus lenses and the like includes one or a plurality of lenses.

The lens driver 112 drives the focus lens and the like in the optical system 110. The lens driver 112 includes a motor, and moves the focus lens along the optical axis of the optical system 110 based on the control of the controller 135. The configuration for driving the focus lens in the lens driver 112 can be implemented with a DC motor, a stepping motor, a servo motor, an ultrasonic motor, or the like.

The image sensor 115 captures a subject image formed via the optical system 110 to generate imaging data. The imaging data constitutes image data indicating an image captured by the image sensor 115. The image sensor 115 generates image data for a new frame at a predetermined frame rate (e.g., 30 frames/second). Generation timing of the imaging data and electronic shutter operation in the image sensor 115 are controlled by the controller 135. As the image sensor 115, various image sensors such as a CMOS image sensor, a CCD image sensor, or an NMOS image sensor can be used.

The image sensor 115 performs imaging operations of a still image, a moving image, a through image, or the like. The through image is mainly a moving image, and is displayed on the display monitor 130 in order to allow the user to determine composition for capturing a still image and a moving image for recording, for example. The image sensor 115 is an example of an image sensor in the present embodiment.

The image processor 120 performs various kinds of processing on the imaging data output from the image sensor 115 to generate the image data, or performs various kinds of processing on the image data to generate images to be displayed on the display monitor 130. Various kinds of processing include white balance correction, gamma correction, YC conversion processing, electronic zoom processing, compression processing, expansion processing, and the like, but are not limited to these. The image processor 120 may be configured with a hard-wired electronic circuit, or may be configured with a microcomputer, a processor, or the like using a program.

The display monitor 130 is an example of a display that displays various kinds of information. For example, the display monitor 130 displays an image (through image) represented by the image data which is captured by the image sensor 115 and on which image processing by the image processor 120 is performed. In addition, the display monitor 130 displays a menu screen or the like for the user to make various settings for the digital camera 100. The display monitor 130 can include a liquid crystal display device or an organic EL device, for example.

The user interface 150 is a collective term for various user interfaces with which operations by the user are received. For example, the user interface 150 includes physical buttons such as a release button and a cursor button, a lever, a dial, a switch, a joystick, a touch panel, and the like. The user interface 150 also includes virtual buttons and icons displayed on the display monitor 130. When receiving an operation by the user, the user interface 150 transmits an operation signal corresponding to the user operation to the controller 135.

The controller 135 entirely controls the whole operation of the digital camera 100. The controller 135 includes a CPU and the like, and a predetermined function is implemented with the CPU executing a program (software). The controller 135 may include a processor including a dedicated electronic circuit designed to implement a predetermined function instead of the CPU. That is, the controller 135 can be implemented with various processors such as a CPU, an MPU, a GPU, a DSU, an FPGA, and an ASIC. The controller 135 may include one or a plurality of processors. In addition, the controller 135 may be integrated in one semiconductor chip together with the image processor 120 and the like.

The buffer memory 125 is a recording medium that functions as a work memory for the image processor 120 and the controller 135. The buffer memory 125 is implemented by a dynamic random-access memory (DRAM) or the like. The flash memory 145 is a non-volatile recording medium. The controller 135 may include various internal memories and may incorporate, for example, a ROM. The ROM stores various programs to be executed by the controller 135. The controller 135 may incorporate a RAM that functions as a working area of the CPU.

The card slot 140 is a means into which a detachable memory card 142 is inserted. The card slot 140 can connect the memory card 142 electrically and mechanically. The memory card 142 is an external memory including a recording element such as a flash memory inside. The memory card 142 can store data such as image data generated by the image processor 120.

The communication module 155 is a communication module (circuit) that connects to an external device conforming to a predetermined communication standard for wired or wireless communication. The predetermined communication standard includes, for example, Bluetooth (registered trademark), IEEE802.11, Wi-Fi (registered trademark), USB, and HDMI (registered trademark). The digital camera 100 can communicate with other devices via the communication module 155. The digital camera 100 may communicate directly with other devices via the communication module 155, or may communicate via an access point. The communication module 155 may be connectable to a communication network such as the Internet. The communication module 155 includes, for example, various antennas that transmit and receive various signals such as radio signals.

An audio processor 170 performs various kinds of audio processing on input audio data. In the digital camera 100, audio data received from the earphone 20 via the communication module 155 is input into the audio processor 170 by the control of the controller 135, for example. The various kinds of audio processing may include gain adjustment processing for amplifying or attenuating sounds, for example. The audio processor 170 may be configured with a hard-wired electronic circuit, or may be configured with a microcomputer, a processor, or the like using a program.

In the digital camera 100 of the present embodiment, the audio processor 170 includes a beamformer 172 and an output selector 174, as illustrated in FIG. 2, for example. The beamformer 172 implements a function of controlling a directivity of a sound. Details of the beamformer 172 will be described later. The output selector 174 switches a source of audio data, from among audio data input from a plurality of sources, to select audio data to be output from the audio processor 170. For example, by the output selector 174, the digital camera 100 can switch audio data that is output to the controller 135 and transmitted from the communication module 155 to the earphones 20.

### 1-2. Configuration of Earphone

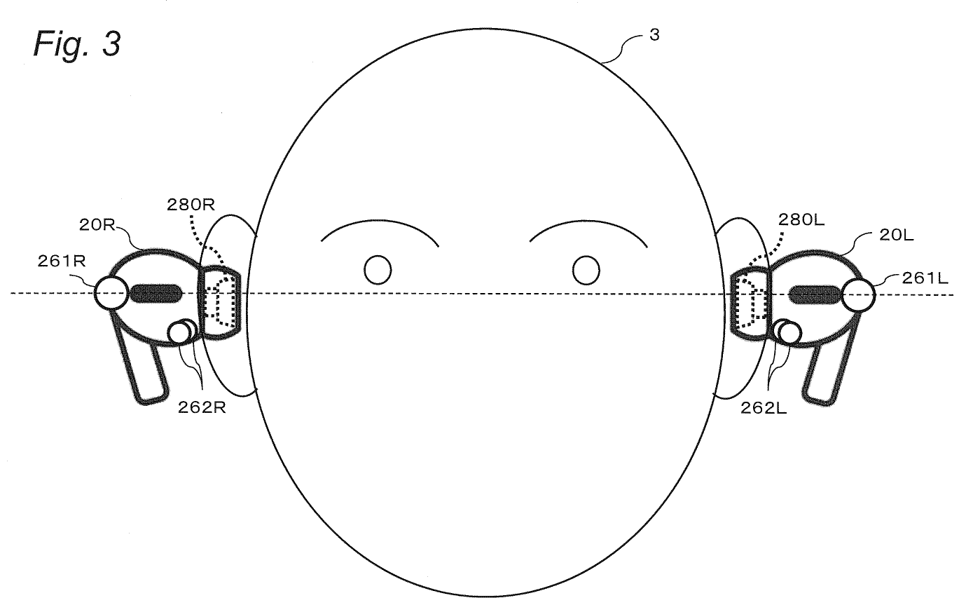

FIG. 3 is a diagram for illustrating the earphone 20 worn by a user 3 in the present system 1. For example, the earphone 20L is worn in the left ear of the user 3, and the earphone 20R is worn in the right ear of the user 3.

For example, as illustrated in FIG. 3, the earphone 20L includes an outer microphone 261L, an inner microphone 262L, and a speaker 280L. The outer microphone 261L for noise cancellation is arranged to collect an external sound, such as an ambient sound. The inner microphone 262L is arranged to collect a sound, as a foreground sound, from the user 3 such as a speaking videographer. In the earphone 20L, the outer microphone 261L, the inner microphone 262L, and the speaker 280L are arranged in order of a distances from the user 3 on a straight line connecting both ears of the user 3. For example, the inner microphone 262L includes two microphone elements closely positioned. Similarly to the earphone 20L, the earphone 20R includes an outer microphone 261R, an inner microphone 262R, and a speaker 280R.

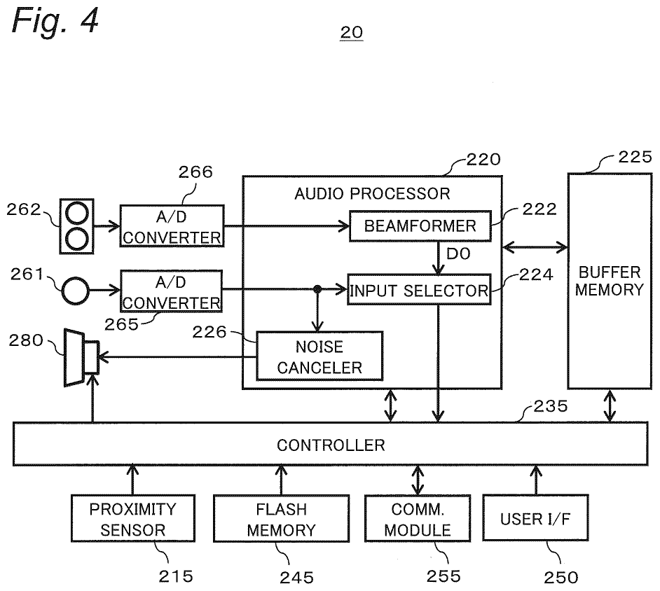

FIG. 4 illustrates the configuration of each earphone 20 in the present system 1. The earphone 20 includes an audio processor 220, a controller 235, a buffer memory 225, a flash memory 245, a user interface 250, and a communication module 255 in addition to the outer microphone 261, the inner microphone 262, and the speaker 280. Furthermore, the earphone 20 includes A/D converters 265 and 266 for the microphones. The earphone 20 includes, for example, a proximity sensor 215.

The outer microphone 261 includes, for example, one microphone element. The outer microphone 261 incorporates a microphone element with a relatively wide band and a high S/N ratio from a viewpoint of performing accurate noise cancellation even in a silent environment, for example.

The inner microphone 262 includes a plurality of microphone elements from a viewpoint of forming a directivity in sound collection of the sound from the speaking user 3. In the present embodiment, an example in which two microphone elements are incorporated will be described, but the inner microphone 262 may include three or more microphone elements.

The outer microphone 261 and the inner microphone 262 convert sounds collected by their microphone elements into analog signals being electric signals, and outputs the signals.

The A/D converter 265 converts the analog signal output from the outer microphone 261 into audio data represented by a digital signal. The A/D converter 266 converts the analog signal from the inner microphone 262 into audio data. The A/D converters 265 and 266 may be configured integrally with the microphone elements of the outer microphone 261 and the inner microphone 262. That is, the outer microphone 261 and the inner microphone 262 may be digital microphones including A/D converters and the like.

The audio processor 220 receives the audio data output from each of the A/D converters 265 and 266, and performs various kinds of audio processing on the received audio data. For example, the various kinds of audio processing may include gain adjustment processing and the like. The audio processor 220 may be configured with a hard-wired electronic circuit, or may be configured with a microcomputer, a processor, or the like using a program.

In the earphone 20 of the present embodiment, the audio processor 220 includes a beamformer 222, an input selector 224, and a noise canceller 226, as illustrated in FIG. 4, for example.

The beamformer 222 realizes a function of controlling the directivity of the sound for the audio data from the inner microphone 262, and outputs audio data D0 in which the directivity is formed. The input selector 224 switches a source of audio data between the audio data D0 in which the audio data from the inner microphone 262 is processed by the beamformer 222, and the audio data from the outer microphone 261, so as to select audio data input into the controller 235. The noise canceller 226 outputs audio data indicating a sound in which the user 3 hardly hears noise, by signal processing or the like that cancels a noise component such as an external environmental sound in the audio data output from the speaker 280, based on the audio data from the outer microphone 261, for example.

The speaker 280 includes, for example, one or more speaker elements, and outputs, to the outside of the earphone 20, sounds from audio data input by the control of the controller 235.

The controller 235 entirely controls the whole operation of the earphone 20. The controller 235 includes a CPU and the like, and a predetermined function is implemented with the CPU executing a program (software). The controller 235 can be implemented with various processors, similarly to the controller 135 of the digital camera 100. The controller 235 may include one or more processors. In addition, the controller 235 may be integrated in one semiconductor chip together with the audio processor 220 and the like.

The buffer memory 225 is a recording medium that functions as a work memory for the audio processor 220 and the controller 235. The buffer memory 225 is implemented by a dynamic random-access memory (DRAM) or the like. The buffer memory 225 holds, for example, various kinds of audio data and the like. The flash memory 245 is a non-volatile recording medium. The controller 235 may include various internal memories and may incorporate, for example, a ROM. The ROM stores various programs to be executed by the controller 235. The controller 235 may incorporate a RAM that functions as a working area of the CPU.

The user interface 250 is a collective term for various user interfaces with which operations by the user are received. For example, the user interface 250 includes a button, a switch, and/or a touch panel. When receiving an operation by the user, the user interface 250 transmits an operation signal according to the user operation to the controller 235.

The communication module 255 is a communication module (circuit) that connects to an external device conforming to a predetermined communication standard for wired or wireless communication, similarly to the communication module 155 of the digital camera 100, for example. The communication module 255 of the earphone 20 in the present embodiment includes, for example, an antenna array that transmits, to an external device connected for communication, radio signals and the like used for direction detection of the earphone 20 from the external device.

The proximity sensor 215 may be, for example, a photoelectric sensor, and detects the presence or absence of an object approaching the proximity sensor 215 according to the amount of received light. Examples of the use of the proximity sensor 215 include detection of whether or not the earphone 20 is worn in the ears of the user 3.

### 2. Operation

An operation of the imaging system 1 configured as described above will be described.

In the present system 1, for example, the digital camera 100, after establishing communication connection for performing data communication with the earphone 20 as illustrated in FIG. 1, performs an operation of moving image shooting according to an operation of the user 3. In the moving image shooting, the digital camera 100 sequentially generates image data by performing imaging operation of through images or moving images. In parallel with the imaging operation, the digital camera 100 of the present system 1 collects sounds by the outer microphone 261 or the inner microphone 262 of the earphone 20 worn by user 3 as illustrated in FIG. 3.

The present system 1 uses the microphones 261 and 262 of the earphone 20 for sound collection in the moving image shooting with the digital camera 100, so that sounds are acquired that are less affected by noise caused by driving a cooling fan and the like or from various lenses of the digital camera 100, for example. Furthermore, with the earphone 20 away from the digital camera 100, degradation of the sound quality can be suppressed as compared with a built-in microphone of the digital camera 100 and a microphone externally attached to an accessory shoe, for example. The degradation of sound quality is caused by noise contained in the collected sounds and caused by the digital camera 100 shaking.

In addition to suppressing the degradation of sound quality due to the noise from the digital camera 100 as described above, the present system 1 can collect sounds with microphones arranged close to both ears of the user 3 in the earphone 20, which is worn by the user 3. This enables the present system 1 to provide enhanced realistic sounds as if the user 3 actually hears, such as binaural sounds.

When the digital camera 100 receives, from the earphone 20, audio data representing the sound collected by each of the microphones 261 and 262, the audio processor 170 (see FIG. 2) processes the audio data. For example, in the digital camera 100 of the present embodiment, the directivity in the audio data from the outer microphone 261 is controlled with the beamformer 172. With such audio processing, in the digital camera 100 of the present embodiment, the directivity can be directed to the front of the user 3 (e.g., the direction of the digital camera 100), or different directivities between the left and right can be formed in stereo recording, for example, according to a shooting scene in which moving image shooting is performed.

Furthermore, the present system 1 can reproduce, by the earphone 20, sounds being collected to be recorded in moving image shooting with the digital camera 100. Thus, with the earphone 20, sound collection and monitoring of the collected sounds can be achieved at the same time. This allows the user 3 to check the sounds to be recorded when the moving image shooting is performed, facilitating acquisition of sounds that meets an intention of the user 3. In addition, by using the earphone 20 for both sound collection and monitoring, the number of pieces of equipment used by the user 3 for moving image shooting can be reduced, and the user 3 can concentrate on the moving image shooting. The operation of the digital camera 100 in the present system 1 will be described as follows.

### 2-1. Connection and Setting of Earphones

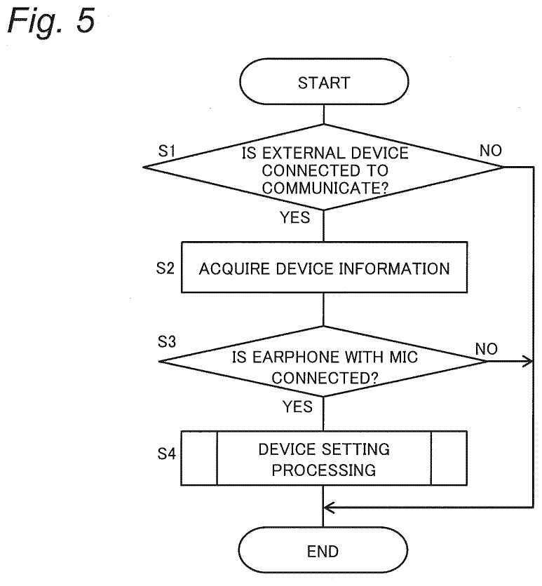

First, an operation will be described with reference to FIGS. 5 to 7B. In the operation, the digital camera 100 of the present system 1 starts communication connection with the earphone 20 and performs setting according to device information held in the connected earphone 20. In the following, an example will be described in which the digital camera 100 and the earphone 20 are connected over Bluetooth.

FIG. 5 is a flowchart illustrating the operation of the digital camera 100 at the time of connection with the earphone 20. For example, the processing illustrated in FIG. 5 is started when the digital camera 100 is activated, and each step in the processing is performed by the controller 135 of the digital camera 100.

The controller 135 determines whether or not an external device such as the earphone 20 is connected for communication, for example, based on information such as a connection request received via the communication module 155 (S1). When the external device is not connected for communication (NO in S1), the controller 135 ends the processing of the present flowchart. After a predetermined period has elapsed from the end of the processing, the processing of step S1 and subsequent steps may be repeated.

When the external device is connected for communication (YES in S1), the controller 135 recognizes the connected device and acquires device information from the connected device with the communication module 155 (S2). The device information includes, for example, a Bluetooth version, an audio standard, a codec, and the like available in the connected device, in addition to identification information for identifying the connected device.

The controller 135 determines whether or not the connected external device is the earphone 20 incorporating the microphones based on the device information (S3). When the connected external device is not the earphone 20 (NO in S3), the controller 135 ends the processing of the present flowchart as a result of the determination that the earphone 20 is not connected.

When the connected external device is the earphone 20 (YES in S3), the controller 135 performs setting to cause the earphone 20 to record and reproduce sounds in the digital camera 100 (S4). In such device setting processing (S4), for example, a distance between the earphones 20L and 20R is set from a viewpoint of accurately performing beamforming on the audio data from the outer microphones 261L and 261R of the earphones 20L and 20R worn in the left and right ears of the user 3, respectively. Details of the device setting processing (S4) will be described later.

When a device other than the earphone 20 is connected to the digital camera 100, setting according to the device may be performed. For example, when earphones without microphones contained are connected, a setting for reproducing sounds with the earphones may be performed. After performing the device setting processing (S4), the controller 135 ends the processing of the present flowchart.

According to the above processing, the digital camera 100 acquires the device information from the external device connected for communication (S2), and when the earphone 20 with the microphones is connected (YES in S3), performs the setting for recording and reproducing sounds with the earphones 20 (S4).

### 2-1-1. Device Setting Processing

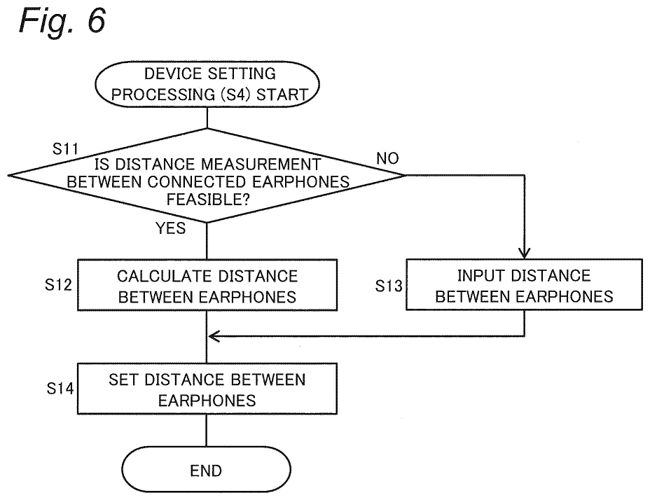

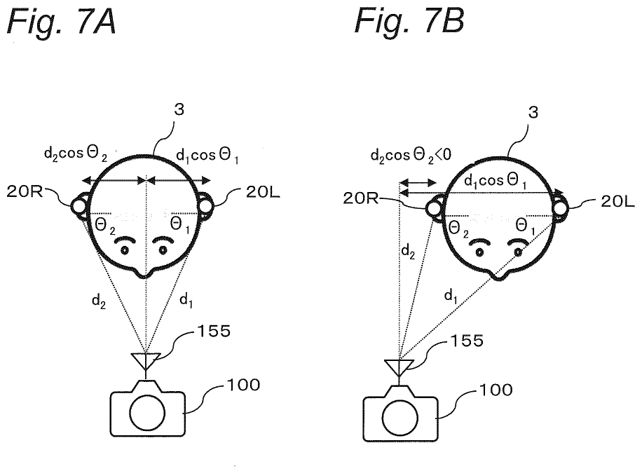

The device setting processing in step S4 in FIG. 5 will be described with reference to FIGS. 6 to 7B.

FIG. 6 is a flowchart illustrating the device setting processing (S4) in the digital camera 100. The processing illustrated in FIG. 6 is, when the earphone 20 is connected to the digital camera 100 (YES in S3), started in a state where the device information acquired in Step S2 in FIG. 5 is held in the buffer memory 125 or the like.

The controller 135 first determines whether or not the distance between the left and right earphones 20L and 20R can be measured with the connected earphone 20 based on the device information (S11). For example, the controller 135 makes the determination in step S11 on such distance measurement based on the Bluetooth version, the audio standard, and the like in the device information. For example, when the Bluetooth version supports the function of detecting the direction of the earphone 20 from a connected apparatus such as the digital camera 100, and the audio standard is LE Audio that enables communication with each of the earphones 20L and 20R from the connected apparatus, the distance measurement is determined to be feasible (YES in S11).

When the distance measurement is feasible (YES in S11), the controller 135 transmits and receives radio signals between the earphones 20R and 20L, for example, and calculates the distance between the earphones 20R and 20L (S12). FIGS. 7A and 7B are diagrams for illustrating the calculation of the distance between the earphones 20R and 20L performed in the digital camera 100.

FIG. 7A illustrates a positional relationship between the communication module 155 of the digital camera 100 and the earphones 20L and 20R worn in the left and right ears of the user 3, respectively. FIG. 7B illustrates a positional relationship different from that of FIG. 7A.

First, the controller 135 determines distances d1 and d2 between the digital camera 100 and the earphones 20L and 20R by, for example, channel sounding using phase-based ranging (PBR). For example, two or more signals having different frequencies such as a sweep signal are transmitted and received to and from the earphone 20L, and a phase change between the transmitted signal and the received signal is calculated for each frequency. Then, a phase difference due to the change in frequency is calculated from the phase changes at each of the frequencies, and based on a relation that the phase difference is caused in round trip of a path of the distance d1 through the signal transmission and reception, the distance d1 can be calculated. The distance d2 between the earphone 20R and the digital camera 100 is calculated similarly to the distance d1.

Furthermore, in the imaging system 1 of the present embodiment, the radio signals for the direction detection are sent from the earphone 20 of which direction to be specified, and the digital camera 100 receives the signals with the communication module 155, whereby the direction detection is performed by an angle of departure (AoD). Hereinafter, an example will be described in which a plurality of antennas included in the antenna array of each of the earphones 20L and 20R are arranged on the straight line connecting both ears of the user 3 as indicated by a broken line in FIG. 3. For example, as illustrated in FIG. 7A, signals are sent from the antenna array of the earphone 20L to the digital camera 100 at an angle of departure θ1. The direction of the earphone 20L toward the digital camera 100 can be expressed by this angle of departure θ1.

For example, the angle of departure θ1 can be calculated from the phase difference of the signals from the respective antennas in the antenna array of the earphone 20L. The phase difference between the antennas can be calculated, for example, from intensities of an in-phase (cosine) component and a quadrature (sine) component in IQ data calculated based on the signals. An angle of departure θ2 indicating the direction of the earphone 20R toward the digital camera 100 is calculated similarly to θ1.

A distance D12 between the earphones 20R and 20L is calculated by the following formula from a trigonometric relationship as illustrated in FIG. 7A, for example.

D12=d1 cos θ1+d2 cos θ2

For example, as illustrated in FIG. 7B, the above calculation formula of the distance D12 also holds when the positional relationship between the digital camera 100 and the earphones 20R and 20L is different from that in the example in FIG. 7A.

For example, after calculating the distance D12 between the earphones 20R and 20L as described above (S12), the controller 135 sets the calculated distance D12 to the beamformer 172 (S14).

On the other hand, when determining that the distance measurement between the connected earphones 20R and 20L is unfeasible (NO in S11), for example, the controller 135 receives a user operation of inputting the distance D12 between the earphones 20R and 20L via the user interface 150 (S13). In step S13, the controller 135 may cause the display monitor 130 to display a predetermined setting menu screen or the like. The distance D12 may be directly input with a numerical value in a predetermined unit, or may be selected from a plurality of options stored in advance in the flash memory 145 or the like. The controller 135 sets the received distance D12 to the beamformer 172 (S14).

After setting the distance D12 between the earphones 20R and 20L (S14), the controller 135 ends the processing of the present flowchart.

According to the above device setting processing (S4), when the distance measurement between the connected earphones 20R and 20L is feasible (YES in S11), the digital camera 100 calculates the distance D12 (S12), and sets the distance D12 to the beamformer 172 (S14). When the distance measurement is unfeasible (NO in S11), the distance D12 input via the user interface 150 is set (S13 and S14). This makes it possible to accurately perform the audio processing on the audio data by the beamformer 172, such as beamforming in which the arrangement of the outer microphones 261L and 261R worn on the head of the user 3 is reflected, for example, according to the earphone 20 connected to the digital camera 100.

By calculating the distance D12 in the digital camera 100 (S12), the distance D12 can be calculated more accurately than a case of calculating the distance by the communication of radio signals between the earphones 20L and 20R, mitigating the influence of the head of the user 3 which interferes with the signals, for example.

In the above description, the example is described in which in calculating the distance D12 (S12), the plurality of antennas in the antenna array of each of the earphones 20L and 20R are arranged on the straight line connecting both ears of the user 3. The plurality of antennas may not be arranged on the straight line. For example, an offset indicating a difference between the straight line connecting the plurality of antennas and the straight line connecting both ears of the user 3 may be included in the device information as an angle formed by the two straight lines or the like. In step S12, the distance D12 may be calculated based on the offset in the device information.

In the above description, the example is described in which in calculating the distance D12 (S12), the digital camera 100 performs the direction detection according to the angle of departure (AoD) with the antenna array incorporated in the earphone 20. Such an antenna array for the direction detection may be incorporated in the communication module 155 or the like of the digital camera 100, and in step S12, the direction detection may be performed with a reception angle (AoA: angle of arrival) instead of the AoD.

The example is described above in which, when the distance measurement between the earphones 20R and 20L is unfeasible (NO in S11), the distance D12 is input by the user operation (S13). For example, the controller 135 may determine from the identification information of the earphone 20, whether or not the earphone 20 was connected in the past, and for the earphone 20 connected in the past, the controller 135 may set again the distance D12 set at the time of the connection in the past. The distance D12 at the time of the connection in the past is stored in the flash memory 145 as a registered distance D12 in association with, for example, the identification information. Even when the distance measurement is feasible (YES in S11), the setting in step S14 may be performed by reading the registered distance D12 for the earphone 20 connected in the past.

Furthermore, in the above example, the user 3 may be able to select whether or not to use the registered distance D12 with the user interface 150, and a message or the like prompting the user 3 to select may be displayed on the display monitor 130. For example, in step S12, when any of the distances d1 and d2 and/or the angles of departure θ1 and θ2 does not fall within a predetermined range, a message or the like may be displayed that prompts the user 3 to change the wearing position of the earphone 20 and perform step S12 again, or an error in calculation of the distance D12 is notified to the user 3, then a message or the like may be displayed that prompts the user operation similar to step S13. The predetermined range may be set in consideration of a positional relationship between the head of user 3 and the earphones 20R and 20L from a viewpoint of accurately calculating the distance D12.

2-2. Operation Performed with Moving Image Shooting

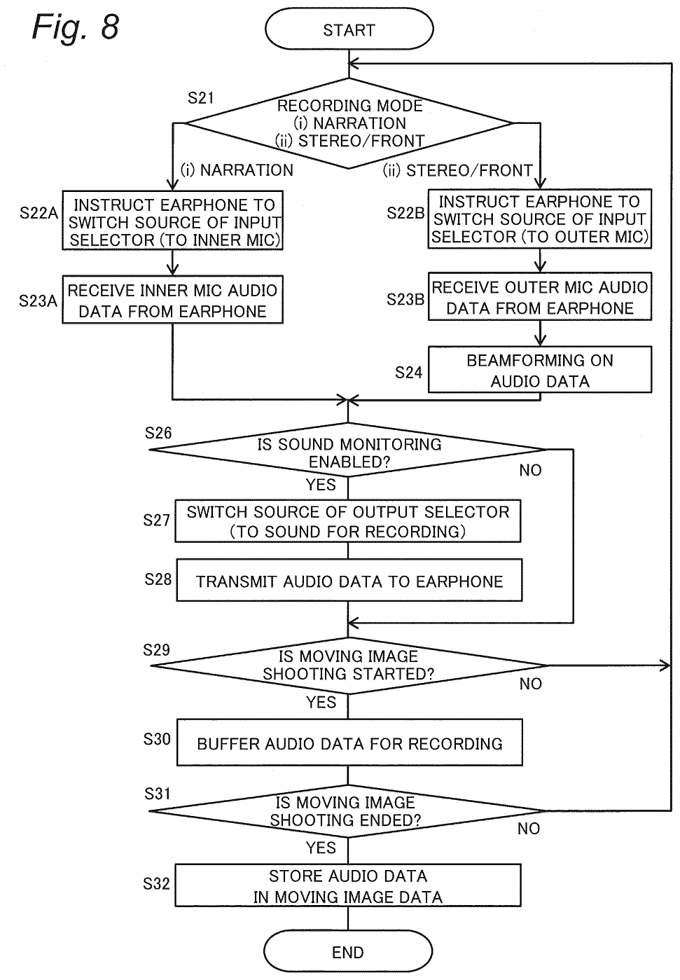

An operation when moving image shooting is performed will be described with reference to FIGS. 8 to 11B. The operation is performed after the setting of the distance D12 between the earphones 20R and 20L to which the digital camera 100 is connected for communication as described above.

FIG. 8 is a flowchart illustrating the operation in the digital camera performed with moving image shooting. Processing illustrated in FIG. 8 is started, for example, when the digital camera 100 becomes a standby state for moving image shooting after the distance D12 is set. In the standby state, the through image is displayed on the display monitor 130 before the digital camera 100 starts a shooting operation to record image data and audio data in association with each other. Each step in the the processing in FIG. 8 is performed by the controller 135 in parallel with, for example, an operation in the standby state before the moving image shooting and the shooting operation in the moving image shooting.

### 2-2-1. Beam Forming

The digital camera 100 according to the present embodiment has a plurality of recording modes in which sounds are collected in moving image shooting and recorded in moving image data. The plurality of recording modes are set in advance, for example, to collect sounds having various directivities, with the earphone 20.

For example, in the digital camera 100 of the present embodiment, the beamformer 172 performs beamforming for controlling the directivity of the sound collected by the outer microphone 261 for noise cancellation in the earphone 20. With the beamformer 172, it is possible to control the direction and range of the directivity of the sound collected by each of the outer microphones 261L and 261R to set a physical range for sound collection.

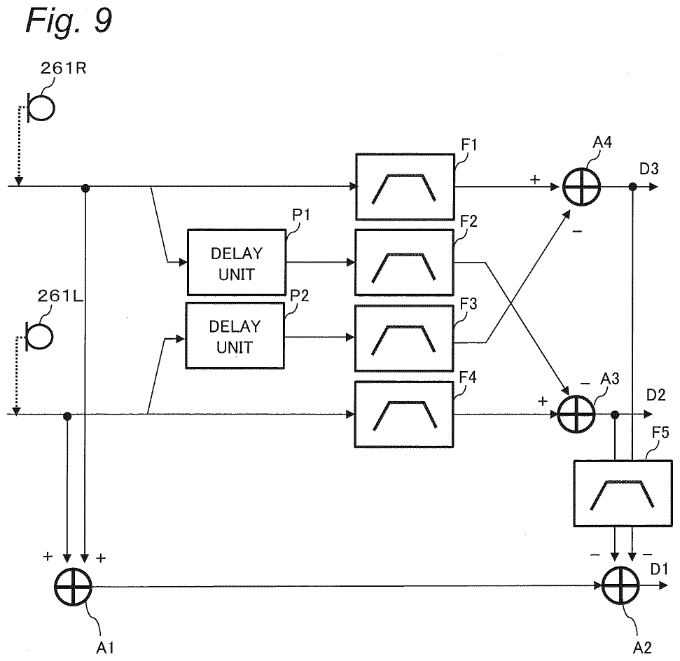

FIG. 9 is a diagram for illustrating the beamformer 172 in the digital camera 100. The controller 135 inputs, into the beamformer 172, audio data received with the communication module 155 from the outer microphones 261L and 261R of the respective earphones 20L and 20R.

The beamformer 172 includes delay units P1 to P2, filters F1 to F5, and adders A1 to A4 as functional components as illustrated in FIG. 9, for example. Each functional component of the beamformer 172 may be implemented by a dedicated hardware circuit. The beamformer 172 adjusts delay periods of sounds collected by the respective outer microphones 261L and 261R with the delay units P1 and P2, and adjusts, with the filters F1 to F5, frequency bands of the sounds with the adjusted delay periods. The beamformer 172 outputs audio data D1 to D3 indicating signed sums, from the adders A1 to A4, of the sounds before or after such adjustment.

For example, the delay unit P1 adjusts the delay period of the sound arriving at the outer microphone 261R from a direction of the right ear of the user 3, by using a phase difference calculated to compensate for a propagation delay according to the distance D12 between the earphones 20R and 20L. Similarly to the delay unit P1, the delay unit P2 adjusts the delay period of the sound arriving at the outer microphone 261L from a direction of the left ear of the user 3, by using the phase difference according to the distance D12. The filters F1 to F5 are, for example, band pass filters. A filter characteristic such as a pass band is set to each of the filters from the viewpoint of improving the S/N ratio of the audio signal by suppressing noise.

### 2-2-2. Recording Mode

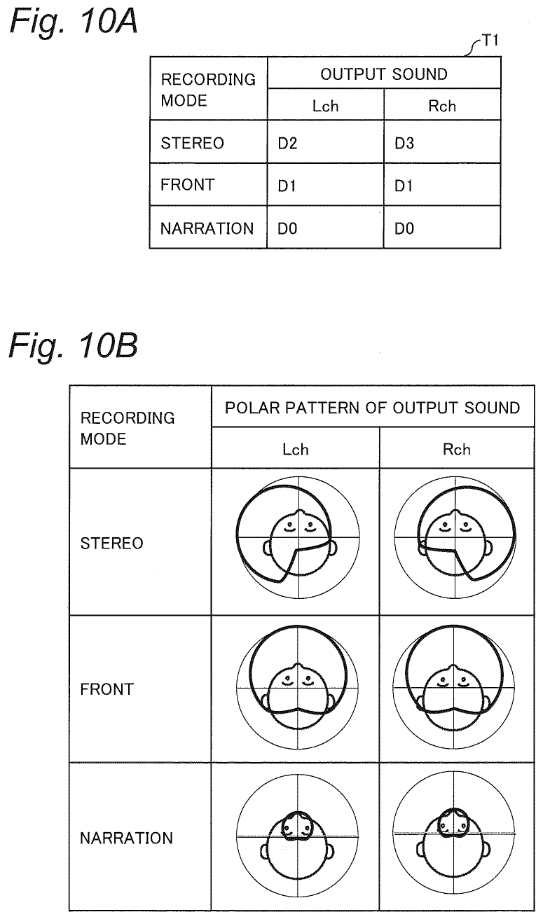

FIGS. 10A and 10B are diagrams for illustrating the recording modes in the digital camera 100. For example, as illustrated in FIGS. 10A and 10B, the digital camera 100 has recording modes of “stereo”, “front”, and “narration”. A recording mode table T1 illustrated in FIG. 10A is used to manage the audio data recorded as the sounds output from the respective speakers 280L and 280R of the left and right earphones 20L and 20R for each recording mode. For example, the recording mode table T1 is stored in advance in the flash memory 145. “Lch” and “Rch” in FIGS. 10A and 10B each indicates a channel in audio data of stereo sound and corresponds to the sound output from each of the speakers 280L and 280R.

For example, when the recording mode is the stereo mode, as illustrated in FIG. 10A, the digital camera 100 records, in the channels Lch and Rch, the respective audio data D2 and D3 generated by the beamformer 172. FIG. 10B illustrates polar patterns indicating directivities formed in output sounds of the respective channels Lch and Rch for each recording mode. For example, as illustrated in FIGS. 10A and 10B, in the stereo mode, the audio data D2 in which the sound from the direction of the left ear is emphasized is recorded in the channel Lch, and the audio data D3 in which the sound from the direction of the right ear is emphasized is recorded in the channel Rch.

When the recording mode is the front mode, as illustrated in FIG. 10A, the digital camera 100 records, in both channels Lch and Rch, the audio data D1 generated by the beamformer 172. For example, as illustrated in FIG. 10B, the audio data D1 is generated such that the sounds in front of the user 3 are emphasized. The filter F5 of the beamformer 172 illustrated in FIG. 9 may have a filter characteristic set to cause a frequency band included in human voice to pass from the audio data D2 and D3. The beamformer 172 is not limited to the example of FIG. 9, and may not include the filter F5.

Furthermore, when the recording mode is the narration mode, the digital camera 100 of the present embodiment records, in both of the channels Lch and Rch, the audio data D0 (see FIG. 4) generated based on the audio data from the inner microphone 262, which is provided for voice of speech, in the earphone 20. For example, as illustrated in FIG. 10B, the audio data D0 is generated such that the sounds near the mouth of the user 3 are emphasized, with the beamformer 222 of the earphone 20.

### 2-2-3. Recording Operation

The digital camera 100 records the sounds acquired from the earphone 20 at the time of the moving image shooting according to the recording modes as described above. Returning to FIG. 8, such recording operations will be described.

First, the controller 135 determines which one of (i) the narration mode and (ii) the stereo or front mode the recording mode set to the digital camera 100 is selected (S21). In the digital camera 100 of the present embodiment, the recording mode is set by a user operation selecting one mode with the user interface 150 from, for example, the three modes illustrated in FIGS. 10A and 10B using a setting menu or the like displayed on the display monitor 130.

When the recording mode is the narration mode ((i) in S21), the controller 135 instructs the earphone 20 to switch the source of the input selector 224 to the audio data D0 from the inner microphone 262 (S22A). For example, the controller 135 transmits, as the instruction, a control signal for changing the source of the input selector 224 to the controller 235 of the earphone 20 via the communication modules 155 and 255.

The controller 135 receives, via the communication module 155, the audio data D0 from the earphone 20 (S23A). The audio data D0, which indicates the sound collected by the inner microphone 262, is output by the beamformer 222.

On the other hand, when the recording mode is the stereo mode or the front mode ((ii) in S21), the controller 135 instructs the earphone 20 to switch the source of the input selector 224 to the audio data from the outer microphone 261 (S22B). For example, similarly to step S22A, a control signal is transmitted to the controller 235 of the earphone 20.

The controller 135 receives, via the communication module 155, audio data indicating the sound collected by the outer microphone 261, from the earphone 20 (S23B).

The controller 135 performs, by the beamformer 172, beamforming corresponding to the set recording mode of the stereo mode or the front mode, on the received audio data from the outer microphone 261 (S24). For example, in step S24, the controller 135 calculates a phase difference to be set to the delay units P1 and P2 based on the distance D12 set to the beamformer 172. This phase difference 8 is calculated by, for example, the following formula. “f” is a frequency of the audio signal represented by the audio data, and “c” is the sound speed.

δ=D12/2πfc

After receiving the audio data D0 from the result of the sound collection by the inner microphone 262 (S23A) or after performing the beamforming on the audio data from the outer microphone 261 (S24), the controller 135 determines whether or not the sound monitoring is set to be enabled (S26). In the digital camera 100 of the present embodiment, whether or not to reproduce sounds for recording to be recorded in the moving image shooting can be set by enabling or disabling the monitoring. This setting is performed by a user operation using a setting menu or the like, for example, before the processing of the present flowchart is performed.

When the monitoring is enabled (YES in S26), the controller 135 switches the source of the output selector 174 in the audio processor 170 to the audio data for recording acquired in step S23A or step S24 (S27). This makes it possible to reproduce, instead of the recorded sound that is already recorded in the moving image data, the sound for recording that is to be recorded when performing the shooting operation, for example, based on the audio data output from the audio processor 170.

The controller 135 transmits the audio data output as the sound for recording from the audio processor 170 to the earphone 20 via the communication module 155 (S28).

After transmitting the audio data to the earphone 20 (S28), the controller 135 determines whether or not the shooting operation of a moving image is started by a user operation with the user interface 150, for example (S29).

When the monitoring is not enabled (NO in S26), the controller 135 proceeds to step S29 without performing the processing in steps S27 and S28.

When the shooting operation is not started (NO in S29), the controller 135 repeats the processing of step S21 and subsequent steps. For example, when a user operation changing the recording mode is input via the user interface 150 in the standby state of the moving image shooting, the controller 135 acquires audio data for recording from the audio data of the sound collected by the earphone 20, according to the changed recording mode (S21 to S24). This facilitates acquiring sounds intended by the user 3 even when the shooting scene changes.

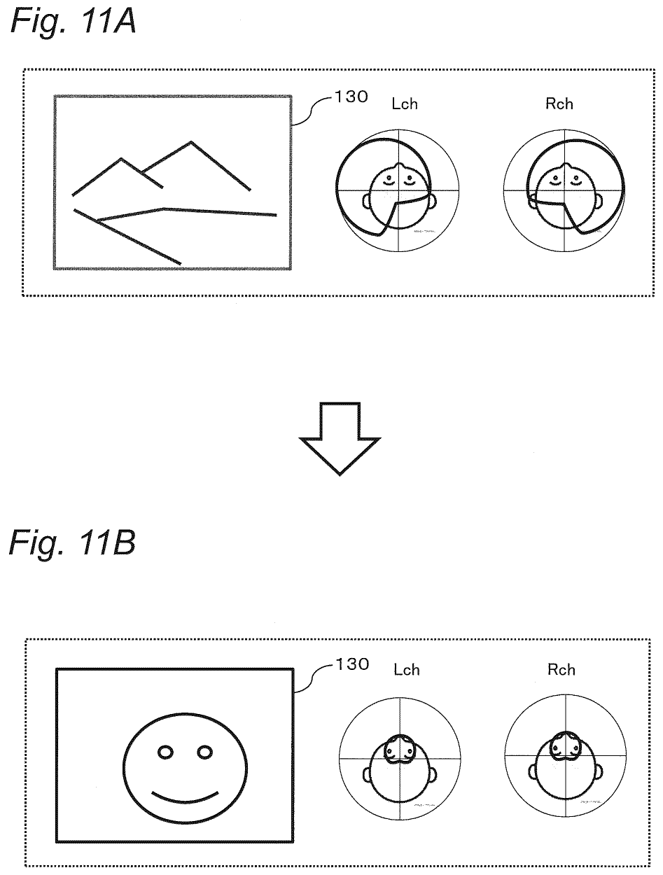

FIGS. 11A and 11B are diagrams for illustrating an example of changing the recording mode in the moving image shooting. For example, assuming a case where the recording mode is set to the stereo mode to record environmental sounds in a landscape shooting scene, as illustrated in FIG. 11A, and the shooting scene changes to other shooting scenes such as taking selfies by the user 3 as illustrated in FIG. 11B. In this case, the recording mode is changed to the narration mode, and the sound from the speaking user 3 can be recorded with the inner microphone 262 of the earphone 20.

Furthermore, when the sound monitoring is enabled (YES in S26), the user 3 can check the sound for recording reproduced from the speaker 280 of the earphone 20, and perform adjustment such as change of the recording mode. This makes it easy to avoid unintended recording due to a mistake by the user 3. Examples of the mistake include that the user 3 erroneously sets the recording mode, and that when the digital camera 100 includes a built-in microphone, sound collection by the built-in microphone is mistakenly set. Furthermore, for example, even when, as a result of the monitoring before the shooting operation, the sound is different from an intended sound in view of noise in the environment around the user 3, the volume of the recorded sound, and the like, the sound intended by the user 3 can be easily acquired by adjusting the recording mode.

Returning to FIG. 8, when the shooting operation of a moving image is started (YES in S29), the controller 135 holds the audio data for recording in the buffer memory 125 or the like (S30).

For example, the controller 135 determines whether or not the shooting operation of a moving image is finished by a user operation via the user interface 150 (S31).

When the shooting operation is not finished (NO in S31), the controller 135 repeats the processing of step S21 and subsequent steps, for example.

When the shooting operation is finished (YES in S31), the controller 135 stores, in moving image data, the audio data held in the buffer memory 125 (S32), and records the moving image data in the memory card 142 or the like. Thereafter, the controller 135 ends the processing of the present flowchart.

According to the above processing, when performing moving image shooting in the digital camera 100, the audio data collected by the outer microphone 261 or the inner microphone 262 of the earphone 20 can be acquired according to the set recording mode (S21 to S23A and S23B). Then, the audio data from the earphone 20 can be recorded as the sounds in the moving image data shot by the digital camera 100 (S29 to S32). Furthermore, the digital camera 100 of the present embodiment performs the beamforming on the audio data from the outer microphone 261 based on the phase difference calculated from the distance D12 between the earphones 20L and 20R (S24). This makes it possible to accurately form the directivity in sound collection such as in the stereo mode and the front mode illustrated in FIG. 10B.

Furthermore, when the sound monitoring is enabled in the moving image shooting (YES in S26), the sounds for recording are reproduced from the speaker 280 of the earphone 20 (S27 to S29). This makes it possible, for example, to check whether sounds intended by the user 3 are recorded.

In the above description, the example is described in which, after the start of the moving image shooting (YES in S29) and when the moving image shooting is not finished (NO in S31), the processing of step S21 and subsequent steps is repeated. In this example, even in the shooting operation of a moving image, sounds for recording can be reproduced according to the setting of the monitoring (S26 to S28), and, for example, a change of the recording mode or the like may be performed. Furthermore, when moving image shooting is not started (NO in S29), the controller 135 repeats the processing of steps S21 to S29 until moving image shooting is started (YES in S29), and, for example, is able to monitor sounds for recording and change the recording mode.

### 2-3. Reproducing Operation

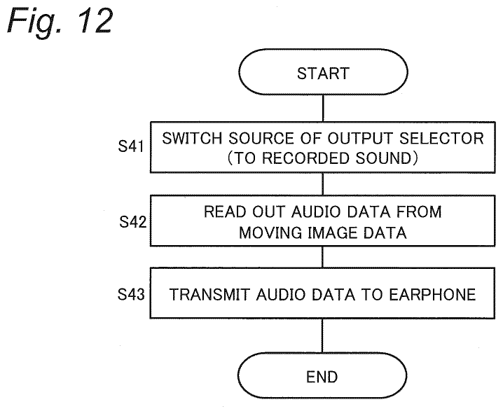

The digital camera 100 of the present embodiment records the moving image data in which the audio data is stored by the recording operation when performing the moving image shooting as described above, and then outputs the sounds from the earphone 20 in reproducing the recorded moving image data. Such reproducing operations will be described with reference to FIG. 12.

FIG. 12 is a flowchart illustrating the reproducing operation of the digital camera 100 after the moving image shooting. The processing illustrated in FIG. 12 is started in a state where moving image data is recorded in the memory card 142, for example. Each step in the the processing in FIG. 12 is performed by the controller 135.

First, the controller 135 switches the source of the output selector 174 in the audio processor 170 to the recorded audio data such as the audio data stored in the moving image data (S41). This makes it possible to reproduce the recorded sounds, instead of the sounds for recording, for example, based on the audio data output from the audio processor 170.

Next, the controller 135 reads out audio data from the recorded moving image data so as to reproduce the recorded sound (S42).

The controller 135 transmits the recorded audio read out, to the earphone 20 via the communication module 155 (S43). This makes it possible to reproduce the audio data with the speaker 280 of the earphone 20.

According to the above processing, the digital camera 100 can reproduce, for monitoring, the sounds collected by the earphone 20 in the moving image shooting, as well as outputting the sounds from the earphone 20 also in reproducing the shot moving image.

### 3. Summary

As described above, in the present embodiment, the digital camera 100 as an example of the imaging apparatus includes the image sensor 115 as an example of an image sensor, the communication module 155 as an example of a communicator, the audio processor 170, and the controller 135 as an example of a controller. The image sensor 115 is configured to capture an image of a subject to generate image data. The communication module 155 is configured to perform data communication with the earphone 20 as an example of a sound collector. The audio processor 170 is configured to form the directivity in the sound collected by the earphone 20. The controller 135 is configured to control sound collection by the earphone 20. The earphone 20 is worn on the head of the user 3, and includes the plurality of microphones 261 and 262 arranged at respective predetermined positions on the head wearing the earphone. The controller 135 controls the communication module 155 to receive, from the earphone 20, the audio data indicating the sound collected with the image sensor 115 capturing the image (S22A to S23B). The controller 135 controls the directivity in the received audio data by the audio processor 170 according to the arrangement of the plurality of microphones 261 and 262 on the head wearing the earphone 20, and outputs controlled audio data to be recorded in association with the image data generated by the image sensor 115 (S24, S30, and S32).

According to the above digital camera 100, for example, in shooting a moving image or the like, sounds collected when performing the image capturing can be acquired from the plurality of microphones 261 and 262 of the earphone 20 worn by the user 3. Then, a sound with the directivity controlled according to the arrangement of the microphones 261 and 262 of the earphone 20 worn on the head of the user 3, is acquired. This makes it possible, for example, to collect a binaural sound as if the user 3 hearing, and control the directivity in the collected sound. This facilitates acquiring a sound that meets the intention of the user 3 using the earphone 20.

In the present embodiment, the sound collector includes two earphones 20L and 20R each including one or more microphones of the plurality of microphones 261 and 262. The communication module 155 performs the data communication with both of the two earphones 20L and 20R. For example, the earphone 20L includes the outer microphone 261L and the inner microphone 262L, and the earphone 20R includes the outer microphone 261R and the inner microphone 262R (see FIG. 3). Thus, the digital camera 100 can receive the audio data of the sound collected by each of the microphones from each of the earphones 20L and 20R.

In the present embodiment, the audio processor 170 forms the directivity in the received audio data based on the phase difference between the audio signals output from the outer microphones 261L and 261R, which are examples of the two microphones in the earphone 20 (S24). This makes it possible to form different directivities between the left and right as the stereo sound based on the audio data from each of the outer microphones 261L and 261R of the earphones 20L and 20R, and to form the directivity to emphasize the sound from a certain direction (see FIGS. 9, 10A, and 10B).

In the present embodiment, the plurality of microphones of the earphone 20 include the outer microphone 261, which is an example of a first microphone arranged to collect an ambient sound around the earphone 20 (see FIG. 3). The controller 135 causes the audio processor 170 to form the directivity in the ambient sound from the outer microphone 261 (step S24). This makes it possible, for example, to collect a sound by the outer microphone 261 that is provided for noise cancellation in the earphone 20 and that has characteristics such as relatively wide band and a high S/N ratio, and to accurately acquire the sound with the directivity controlled.

In the present embodiment, the digital camera 100 has the plurality of recording modes as examples of a plurality of sound collection modes to collect sounds performing image capturing by the image sensor 115 (see FIGS. 10A and 10B). The plurality of recording modes includes a first mode (e.g., the stereo mode and/or the front mode) in which sounds are collected by the outer microphone 261. The first mode is not limited to the stereo mode and the front mode as illustrated in FIGS. 10A and 10B, and may be a recording mode for collecting a sound to which a directivity different from those in the examples of FIGS. 10A and 10B is formed.

In the present embodiment, the plurality of microphones of the earphone 20 further include the inner microphone 262, which is an example of a second microphone arranged to collect a foreground sound from the user 3. The plurality of recording modes in the digital camera 100 include a second mode (e.g., the narration mode) in which the foreground sound is collected by the inner microphone 262. According to such a recording mode, for example, the sound from the speaking user 3 can be accurately acquired.

In the present embodiment, the digital camera 100 further includes the user interface 150 configured to receive the user operation selecting a recording mode from the plurality of recording modes. When the selected recording mode is the narration mode ((i) in S21), the controller 135 receives first audio data from the inner microphone 262 (S22A and S23A). When the selected recording mode is the stereo mode or the front mode ((ii) in S21), the controller 135 controls the communication module 155 to receive second audio data from the outer microphone 261 (S22B to S23B). This makes it possible to acquire the sounds from the different microphones of the earphone 20 according to the recording mode selected by the user operation.

In the present embodiment, the earphone 20 includes the speaker 280. The controller 135 controls moving image shooting in which the controlled audio data output from the audio processor 170 as the sound for recording, is recorded in association with image data, for example. The controller 135 controls the communication module 155 to transmit the controlled audio data of the sound for recording to the earphone 20 before the moving image shooting such as the standby state and during the moving image shooting (S27, and S28 to S31). This makes it possible to receive, from the earphone 20, the audio data of the sound for recording in such shooting standby state before the moving image shooting, and reproduce the audio data from the speaker 280. Thus, the user 3 can monitor the sound for recording and this facilitates setting of the recording mode according to the intention of the user 3.

In the present embodiment, the digital camera 100 further includes the user interface 150 configured to receive a user operation selecting the recording mode, which is an example of a user operation selecting, from a plurality of types, the directivity formed in the sound from the earphone 20. In response to the user operation in the user interface 150 (S21), the controller 135 of the digital camera 100 controls the audio processor 170 to form the directivity in the received audio data from the earphone 20 (S24). This makes it possible to change the type of the directivity in the sound collection by selecting the recording mode according to a shooting scene in the digital camera 100. This further facilitates acquiring the sound that meets the intention of the user 3.

In the present embodiment, the imaging system 1 includes the digital camera 100 and the earphone 20 (see FIG. 1). For example, as illustrated in FIG. 2, the earphone 20 includes the communication module 255 as an example of a device communicator configured to perform data communication with the digital camera 100, and the controller 235 as an example of a device controller configured to transmit via the communication module 255 to the digital camera 100, the audio data indicating the sound collected by one or more microphones of the plurality of microphones 261 and 262. According to the present system 1, the digital camera 100 can acquire the sounds collected by the plurality of microphones 261 and 262 of the earphone 20, through data communication with the earphone 20.

### OTHER EMBODIMENTS

As described above, the first embodiment is described as an example of the technique disclosed in the present application. However, the technique in the present disclosure is not limited to this, and can also be applied to embodiments in which changes, substitutions, additions, omissions, and the like are made as appropriate. In addition, it is also possible to combine components described in the above embodiment to form a new embodiment. Thus, other embodiments will be exemplified below.

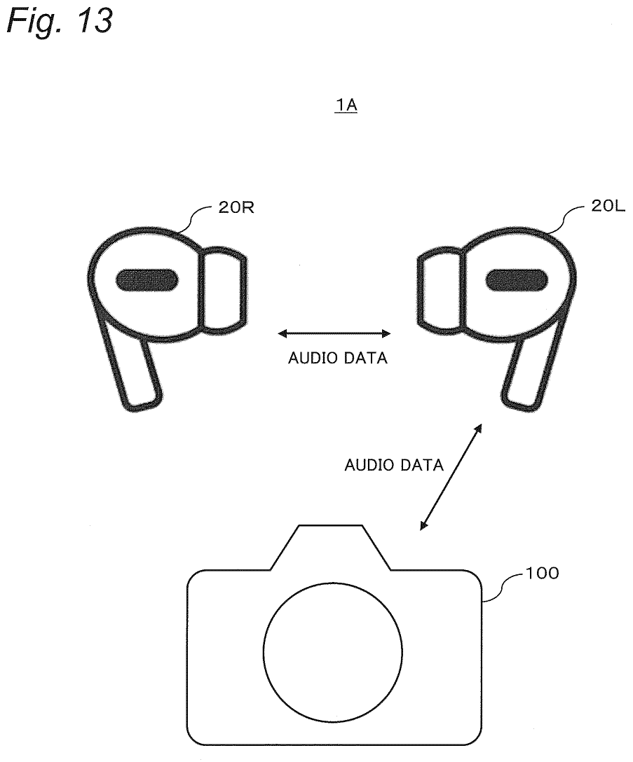

In the first embodiment, for example, as illustrated in FIG. 1, the example is described in which the digital camera 100 performs data communication with both of the earphones 20L and 20R in the imaging system 1. The digital camera 100 may perform data communication with only one of the earphones 20L and 20R. Such a modification of the first embodiment will be described with reference to FIG. 13.

Hereinafter, an imaging system 1A according to the present modification will be described while descriptions of the configurations and operations similar to those of the imaging system 1 according to the first embodiment will be omitted as appropriate.

FIG. 13 is a diagram for illustrating the imaging system 1A according to the modification of the first embodiment. In the present system 1A, earphones 20L and 20R are connected for communication with each other to transmit and receive audio data and the like. For example, a digital camera 100 of the present example is connected for communication with, for example, the earphone 20L to transmit and receive audio data and the like. The present system 1A may perform such transmission and reception in accordance with an audio standard such as Bluetooth Classic Audio. Similarly to the above imaging system 1, for example, the present system 1A can also perform sound collection and the like with an earphone 20 in moving image shooting with the digital camera 100.

As described above, in the present modification, a communication module 155 of the digital camera 100 performs data communication with one of the two earphones 20L and 20R. That is, in the present embodiment, the communication module 155 performs data communication with both or one of the two earphones 20L and 20R.

In the first embodiment, the example is described in which, in the device setting processing (S4), the distance D12 between the earphones 20L and 20R is calculated by the direction detection and the distance measurement between the digital camera 100 and the earphone 20 (S12 in FIG. 6). The digital camera 100 of the present embodiment may acquire, for example, an image of selfie by the user 3 wearing the earphone 20 and calculate the distance D12 based on this image, instead of step S12 described above. In the present embodiment, it is not necessary to determine whether or not the distance D12 can be measured (S11).

In the first embodiment, the example is described in which, in the device setting processing (S4), when the distance measurement between the earphones 20L and 20R is unfeasible (NO in S11), the distance D12 is input by the user operation or the like via the user interface 150 (S13). In the digital camera 100 according to the present embodiment, even when the distance measurement is feasible (YES in S11), the distance D12 may be input by the user operation in the same manner as in step S13. In addition, the distance D12 may be input in the same manner as in step S13 regardless of the feasibility of the distance measurement, and the determination in step S11 may not be performed.

In the first embodiment, the example is described in which the audio data from one of the outer microphone 261 and the inner microphone 262 of the earphone 20 is transmitted to the digital camera 100 (S22A to S23B). In the present embodiment, audio data from both of the outer microphone 261 and the inner microphone 262 may be simultaneously transmitted to the digital camera 100. For example, when audio data of two or more channels can be simultaneously transmitted from the earphone 20, instead of steps S22A to S23B, the digital camera 100 may acquire audio data from both of the microphones 261 and 262.

In the above embodiment, for example, the audio data acquired from both of the microphones 261 and 262 may be held in the buffer memory 125 or the like. In the present embodiment, the digital camera 100 may receive a user operation changing the recording mode after moving image shooting, and may update audio data stored in moving image data based on the held audio data according to the changed recording mode.

In the first embodiment, the example is described in which the audio data of the sound for recording is transmitted to the earphone 20, according to the setting of the monitoring, in the standby state before the start of the moving image shooting as well as in the shooting operation after the start of the moving image shooting (S26 to S28). In the present embodiment, the controller 135 may perform the processing of steps S26 to S28 in only one of the cases of before the moving image shooting and during the moving image shooting. As described above, in the present embodiment, the controller 135 controls the communication module 155 (an example of the communicator) to transmit the audio data to the earphone 20 (an example of the sound collector) in at least one of the cases of before the moving image shooting and during the moving image shooting (S26 to S28).

In the first embodiment, the example is described in which the phase difference for adjusting the delay periods of the audio data from the outer microphones 261L and 261R is calculated, and the beamforming is performed by the beamformer 172 of the audio processor 170 (S24). For example, in step S24, a transfer function may be further calculated based on the phase difference and the device information acquired in step S2, and applied to the input audio data. The transfer function outputs the audio data D1 to D3 from the audio data input into the beamformer 172. For example, a filter that compensates a sound according to a characteristic such as sensitivity of the outer microphone 261 may be stored in advance in the flash memory 145 for each model, or type of the earphone 20, and the transfer function including a corresponding filter may be calculated from the identification information of the earphone 20 in the device information.

In the first embodiment, the controller 135 of the digital camera 100 holds, in the buffer memory 125, the audio data acquired from the earphone 20 and stores the audio data in the moving image data recorded in the memory card 142 (S30 and S32). In the present embodiment, the controller 135 may output the audio data to various memories and/or recording media inside or outside the digital camera 100, or may transmit the audio data to the outside via the communication module 155.

In the first embodiment, the example is described in which the earphones 20L and 20R have one outer microphone 261L and one outer microphone 261R, respectively. In the present embodiment, each of the earphones 20L and 20R may have two or more outer microphones 261. The digital camera 100 of the present embodiment may further have a recording mode for collecting sounds to form surround sound or the directivity in any direction. This recording mode is also an example of the first mode to collect the sound from the outer microphone 261.

In the first embodiment, the earphone 20 including the outer microphone 261 and the inner microphone 262 is described as an example of the sound collector. The sound collector of the present embodiment may be, for example, two earphones each having one microphone. For example, each earphone may not include the inner microphone 262, and may include only the outer microphone 261.

In the first embodiment, the example is described in which the digital camera 100 performs the beamforming on the audio data from the outer microphones 261L and 261R (S24). In the present embodiment, the digital camera 100 may not perform the beamforming.

In the first embodiment, the earphone 20 is described as an example of the sound collector. The sound collector of the present embodiment may be, for example, a headset or the like having microphones and speakers and mounted on the head of the user 3.

In the first embodiment, the earphones having the microphones are described as an example of the sound collector. The sound collector of the present disclosure may not include the speaker, and may be, for example, an earphone-like microphone worn like earphones in the ears of the user 3. Such a kind of microphones also makes it possible to provide enhanced realistic sounds as if the user 3 actually hears.

In the first embodiment, the example is described in which the sound collector such as the earphone 20 is mounted on the user 3 being a cameraman using the digital camera 100. In the present embodiment, the sound collector may be mounted on, not limited to the cameraman, and on a subject to be shot with the digital camera 100, for example.

In the first embodiment, the digital camera 100 that acquires sounds using the sound collector is described. In the present embodiment, instead of the digital camera 100, various audio processing apparatuses may acquire a sound using the sound collector. In the present embodiment, similarly to the digital camera 100 of the first embodiment, such an audio processing apparatus may receive audio data from the sound collector such as the earphone 20 and control the directivity in the audio data. The audio processing apparatus of the present embodiment may not have an image shooting function in particular, and may be, for example, a sound recorder.

That is, the audio processing apparatus of the present embodiment includes a communicator configured to perform data communication with the sound collector, an audio processor configured to form a directivity in a sound collected by the sound collector, and a controller configured to control sound collection by the sound collector. The sound collector is worn on the head of a user, and includes a plurality of microphones arranged at respective predetermined positions on the head wearing the sound collector. The controller controls the communicator to receive audio data indicating the sound collected by the sound collector. The controller controls the directivity in the received audio data by the audio processor according to the arrangement of the plurality of microphones on the head wearing the sound collector, and outputs controlled audio data to be recorded. This also facilitates acquiring a sound that meets an intention of the user using the audio processing apparatus.

In the first embodiment, the digital camera 100 including the optical system 110 and the lens driver 112 is illustrated. The imaging apparatus of the present embodiment may not include the optical system 110 and the lens driver 112, and may be, for example, an interchangeable lens type camera.

In the first embodiment, the digital camera is described as an example of the imaging apparatus, but the present disclosure is not limited to this. The imaging apparatus of the present disclosure may be an electronic apparatus having an image capturing function (e.g., a video camera, a smartphone, a tablet terminal, or the like).

### ASPECT EXAMPLES

Hereinafter, various aspects of the present disclosure will be exemplified.

A first aspect according to the present disclosure is an imaging apparatus including: an image sensor configured to capture an image of a subject to generate image data; a communicator configured to perform data communication with a sound collector; an audio processor configured to form a directivity in a sound collected by the sound collector; and a controller configured to control sound collection by the sound collector. The sound collector is worn on a head of a user, and includes a plurality of microphones arranged at respective predetermined positions on the head wearing the sound collector. The controller controls the communicator to receive, from the sound collector, audio data indicating the sound collected with the image sensor capturing the image. The controller controls the directivity in the received audio data by the audio processor according to the arrangement of the plurality of microphones on the head wearing the sound collector, and output controlled audio data to be recorded in association with the image data generated by the image sensor.

A second aspect is the imaging apparatus according to the first aspect, wherein the sound collector includes two earphones each including one or more microphones of the plurality of microphones. The communicator performs the data communication with both or one of the two earphones.

A third aspect is the imaging apparatus according to the first or second aspect, wherein the audio processor forms the directivity in the received audio data based on a phase difference between audio signals output from two microphones in the sound collector.

A fourth aspect is the imaging apparatus according to any of the first to third aspects, wherein the plurality of microphones in the sound collector includes a first microphone arranged to collect an ambient sound around the sound collector. The controller causes the audio processor to form a directivity in the ambient sound from the first microphone.

A fifth aspect is the imaging apparatus according to the fourth aspect, wherein the imaging apparatus has a plurality of sound collection modes to collect sounds performing image capturing by the image sensor. The plurality of sound collection modes includes a first mode in which the ambient sound is collected by the first microphone.

A sixth aspect is the imaging apparatus according to the fifth aspect, wherein the plurality of microphones in the sound collector further includes a second microphone arranged to collect a foreground sound from the user. The plurality of sound collection modes further includes a second mode in which the foreground sound is collected by the second microphone.

A seventh aspect is the imaging apparatus according to the sixth aspect, further including a user interface configured to receive a user operation selecting a sound collection mode from the plurality of sound collection modes. The controller receives first audio data from the first microphone when the selected sound collection mode is the first mode, and controls the communicator to receive second audio data from the second microphone when the selected sound collection mode is the second mode.

A eighth aspect is the imaging apparatus according to any of the first to seventh aspects, wherein the sound collector includes a speaker. The controller controls moving image shooting in which the controlled audio data output from the audio processor is recorded in association with the image data. The controller controls the communicator to transmit the controlled audio data to the sound collector in at least one of a case before the moving image shooting and a case during the moving image shooting.

A ninth aspect is the imaging apparatus according to the eighth aspect, further including a user interface configured to receive a user operation selecting, from a plurality of types, the directivity formed in the sound from the sound collector. The controller controls the audio processor to form the directivity in the received audio data from the sound collector, in response to the user operation in the user interface.

A tenth aspect is an imaging system including the imaging apparatus according to any of the first to ninth aspects and the sound collector. The sound collector includes: a device communicator configured to perform data communication with the imaging apparatus; and a device controller configured to transmit, to the imaging apparatus, the audio data indicating the sound collected by one or more microphones of the plurality of microphones, via the device communicator.

As described above, the embodiments are described as the exemplification of the technique in the present disclosure. To that end, the accompanying drawings and the detailed description are provided.

Therefore, among the components described in the accompanying drawings and the detailed description, not only the component essential for solving the problem, but also the component not essential for solving the problem may be included in order to exemplify the above technique. Therefore, it should not be recognized that these non-essential components are essential immediately because these non-essential components are described in the accompanying drawings and the detailed description.

In addition, since the above embodiments are for illustrating the technique in the present disclosure, various changes, substitutions, additions, omissions, and the like can be made within the scope of the claims or the equivalent thereof.

The present disclosure can be applied to an electronic apparatus that acquires sound in image shooting such as shooting a moving image. The electronic apparatus includes an imaging apparatus such as a digital camera, a video camera, a smartphone, a cam coder, and the like, in addition to a smartphone and a tablet terminal.

1. An imaging apparatus comprising:
an image sensor configured to capture an image of a subject to generate image data;
a communicator configured to perform data communication with a sound collector;
an audio processor configured to form a directivity in a sound collected by the sound collector; and
a controller configured to control sound collection by the sound collector, wherein
the sound collector is worn on a head of a user, and includes a plurality of microphones arranged at respective predetermined positions on the head wearing the sound collector, and
the controller is configured to
control the communicator to receive, from the sound collector, audio data indicating the sound collected with the image sensor capturing the image, and
control the directivity in the received audio data by the audio processor according to the arrangement of the plurality of microphones on the head wearing the sound collector, and output controlled audio data to be recorded in association with the image data generated by the image sensor.

2. The imaging apparatus according to claim 1, wherein
the sound collector includes two earphones each including one or more microphones of the plurality of microphones, and
the communicator is configured to perform the data communication with both or one of the two earphones.

3. The imaging apparatus according to claim 1, wherein
the audio processor is configured to form the directivity in the received audio data based on a phase difference between audio signals output from two microphones in the sound collector.

4. The imaging apparatus according to claim 1, wherein
the plurality of microphones in the sound collector includes a first microphone arranged to collect an ambient sound around the sound collector, and
the controller is configured to cause the audio processor to form a directivity in the ambient sound from the first microphone.

5. The imaging apparatus according to claim 4, wherein
the imaging apparatus has a plurality of sound collection modes to collect sounds performing image capturing by the image sensor, and
the plurality of sound collection modes includes a first mode in which the ambient sound is collected by the first microphone.

6. The imaging apparatus according to claim 5, wherein
the plurality of microphones in the sound collector further includes a second microphone arranged to collect a foreground sound from the user, and
the plurality of sound collection modes further includes a second mode in which the foreground sound is collected by the second microphone.

7. The imaging apparatus according to claim 6, further comprising
a user interface configured to receive a user operation selecting a sound collection mode from the plurality of sound collection modes, wherein
the controller is configured to,
when the selected sound collection mode is the first mode, receive first audio data from the first microphone; and
when the selected sound collection mode is the second mode, control the communicator to receive second audio data from the second microphone.

8. The imaging apparatus according to claim 1, wherein
the sound collector includes a speaker, and
the controller is configured to control moving image shooting in which the controlled audio data output from the audio processor is recorded in association with the image data, and
the controller is configured to control the communicator to transmit the controlled audio data to the sound collector in at least one of a case before the moving image shooting or a case during the moving image shooting.

9. The imaging apparatus according to claim 8, further comprising
a user interface configured to receive a user operation selecting, from a plurality of types, the directivity formed in the sound from the sound collector, and
the controller is configured to,
in response to the user operation in the user interface, control the audio processor to form the directivity in the received audio data from the sound collector.

10. An imaging system comprising:
the imaging apparatus according to claim 1; and
the sound collector, wherein
the sound collector includes:
a device communicator configured to perform data communication with the imaging apparatus; and
a device controller configured to transmit, to the imaging apparatus, the audio data indicating the sound collected by one or more microphones of the plurality of microphones, via the device communicator.
